(19) United States
(12) Patent Application Publication
(10) Pub. No.: US 2008/0299510 A1
(43) Pub. Date: Dec. 4, 2008

(54) METHOD AND APPARATUS FOR TEMPORARY DENTAL VENEERS

(76) Inventors: Jonathan Penchas, Belaire, TX (US); Rick Kline, Sugar Land, TX (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/757,854

(22) Filed: Jun. 4, 2007

(51) Int. Cl. A61C 13/34; A61C 13/20

(52) U.S. Cl. 433/34; 433/213

(57) ABSTRACT

A method for applying a temporary dental veneer on a patient's teeth that includes the steps of positioning a mold on the patient's teeth, the mold containing a material that may be hardened, and hardening the material on the patient's teeth, the hardened material being temporarily affixed on the teeth. The temporarily affixed hardened material becomes unfixed from the patient's teeth from two hours to two weeks after the material is hardened. An apparatus according to the invention includes a mold adapted to receive a material that may be hardened, and a material that may be hardened, wherein the hardened material is adapted to be temporarily affixed to a patient's teeth.

### DESCRIPTION OF THE INVENTION

1. Field of the Invention

The present invention relates generally to a method and apparatus for the application of temporary dental veneers.

2. Background of the Invention

Cosmetic dental procedures are becoming increasingly more popular. Among these types of procedures is the application of dental veneers. Dental veneers are also sometimes called porcelain veneers or dental porcelain laminates. Dental veneers are wafer-thin shells of porcelain or other materials that are bonded onto the front side of teeth so as to create a cosmetic improvement for a tooth. Dental veneers are routinely used by dentists as a way to make cosmetic changes for teeth that are discolored, worn, chipped, or misaligned. The cost of dental veneers can be very significant for some patients. As such, patients often desire some sort of confirmation that the outcome of the procedure will be desirable. Some conventional approaches for confirming the outcome of the procedure utilize computer-based projections. However, such projections are often unsatisfactory to many patients as they give a distorted or unrealistic view of what they will look like. Other confirmation techniques that utilize acrylic molds that fit over the teeth are also unacceptable as they require making an exact mold of the patient's teeth and the subsequent manufacture of an acrylic mold. This process can take several days, at which point the patient may become disinterested in the procedure.

### SUMMARY OF THE INVENTION

In view of the foregoing, the present invention provides a method and apparatus for applying temporary dental veneers. In this way, a patient may receive the temporary dental veneers during a consultation appointment to give them an idea of what permanent veneers will look like on their teeth.

According to one embodiment of the invention, a method for applying a temporary dental veneer on a patient's teeth includes the steps of positioning a mold on the patient's teeth, the mold containing a material that may be hardened, and hardening the material on the patient's teeth, the hardened material being temporarily affixed on the teeth. The temporarily affixed hardened material becomes unfixed from the patient's teeth from two hours to two weeks after the material is hardened.

According to another embodiment of the invention, the method may further include the step of selecting a mold from among a plurality of different molds prior to positioning the mold. The plurality of different molds differ by one or more features, including tooth size, tooth spacing, bite clearance, and number of teeth. The mold may be selected based on aesthetics and or bite clearance.

According to still another embodiment of the invention, the method includes the steps of selecting a mold from among a plurality of different molds, testing a fit of the selected mold on the patient's mouth, selecting a different one of the plurality of different molds if the fit of the selected mold is unacceptable, filling the dental mod with a material that may be hardened, positioning the selected mold filled with the material on the patient's teeth, removing excess material at the gingival margin of the patient's teeth, hardening the material on the patient's teeth, the hardened material being temporarily affixed on the teeth, shaping the mold and the hardened material, and polishing and cleaning the patient's teeth, including the mold and the hardened material.

An apparatus according to one embodiment of the invention includes a mold adapted to receive a material that may be hardened, and a material that may be hardened, wherein the hardened material is adapted to be temporarily affixed to a patient's teeth. The temporarily affixed hardened material becomes unfixed from the patient's teeth from two hours to two weeks after the material is hardened. The mold and the material may be kept separate from each other until the temporary dental veneer is to be applied to a patient's teeth or the mold may be pre-filled with the material. Preferably the mold is made from a clear plastic and the material is a composite or acrylic material that is hardened by exposing it to ultraviolet radiation.

According to yet another embodiment of the invention, a system for applying a temporary dental veneer includes a plurality of different molds, each mold being adapted to receive a material that may be hardened, a material that may be hardened, wherein the hardened material is adapted to be temporarily affixed to a patient's teeth.

It is to be understood that the descriptions of this invention herein are exemplary and explanatory only and are not restrictive of the invention as claimed.

### BRIEF DESCRIPTION OF THE DRAWINGS

FIG. 1 shows a flowchart of the method according to one embodiment of the invention.

FIG. 2 shows the apparatus according to one embodiment of the invention.

FIG. 3 shows a flowchart of the method according to one embodiment of the invention.

### DETAILED DESCRIPTION OF THE INVENTION

Reference will now be made in detail to the present exemplary embodiments of the invention, examples of which are illustrated in the accompanying drawings.

The present invention provides a method and apparatus for applying temporary dental veneers. In this way, a patient may receive the temporary dental veneers during a consultation appointment to give them an idea of what permanent veneers will look like on their teeth.

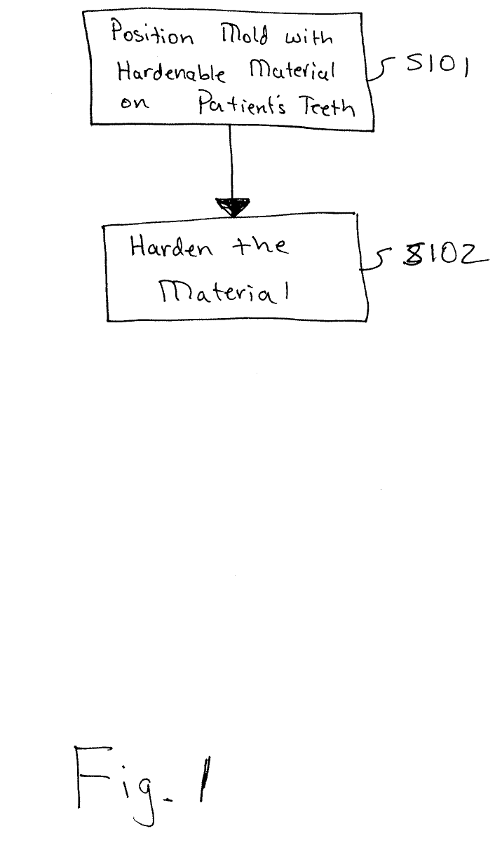

FIG. 1 shows a flowchart of a method for applying a temporary dental veneer on a patient's teeth according to one embodiment of the invention. In step S101, a mold is positioned on the patient's teeth. The mold contains a material that may be hardened. Then in step S102, the material is hardened on the patient's teeth thereby being temporarily affixed to the teeth. The temporarily affixed hardened material becomes unfixed from the patient's teeth from several minutes to several hours after the material is hardened.

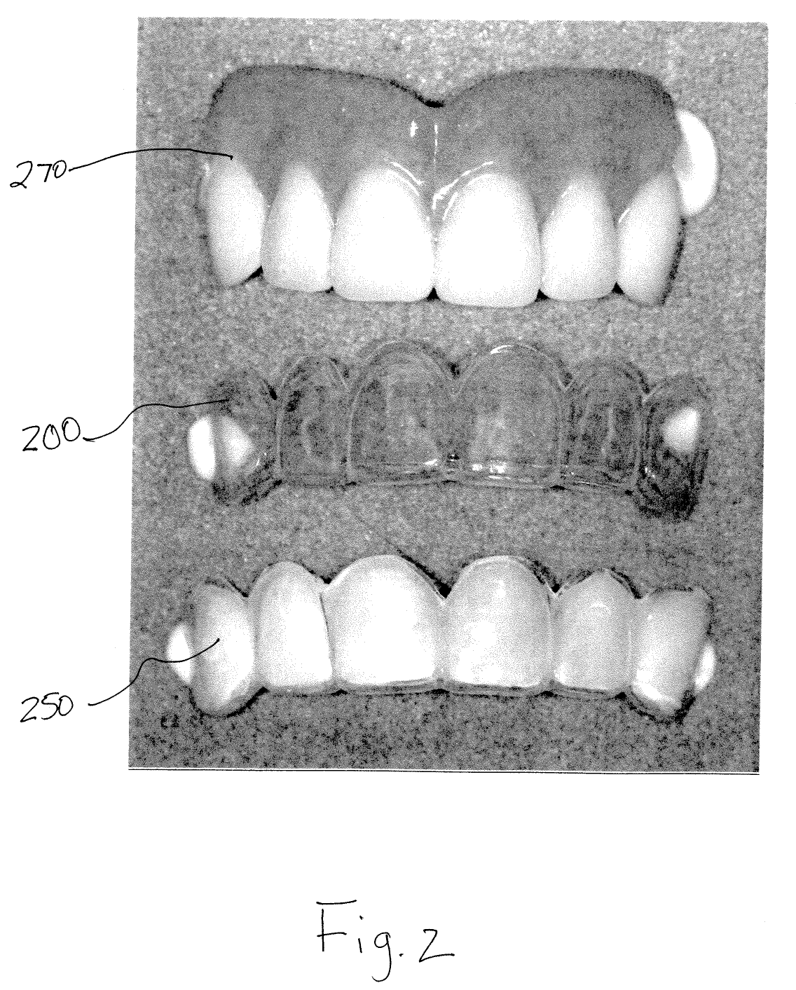

FIG. 2 shows the apparatus according to one embodiment of the invention. Mold 200 is a clear plastic mold in the general shape of a patient's teeth. The mold 200 may be of any suitable composition. In one exemplary embodiment of the present invention, the mold 200 comprises a thermoplastic polymer, such as ethylene vinyl acetate. Only a mold for the upper teeth is shown in FIG. 2. A similar mold for the lower teeth may also be used. The mold 200 is adapted to receive a material 250. The material 250 may include any desired material and may be hardened in any manner, such as a material hardened using UV radiation. In one exemplary embodiment of the present invention, the material 250 may comprise a resin-based matrix (such as urethane dimethacrylate), and an inorganic filler (such as silicon dioxide). The material 250 may include any other desired compound, such as a coupling agent (like silane) to enhance the bonding between the resin-based matrix and the inorganic filler. When the material 250 and mold 200 are positioned on the teeth and the material 250 is hardened, the material 250 become affixed to the teeth. Since the material 250 is not bonded or glued to the teeth with a composite or dental glue, the affixation of the material 250 to the teeth is temporary. The material 250 may be configured to remain on the teeth for any desired duration. In one embodiment of the present invention, for example, the material 250 may be configured to remain on the teeth from between about several minutes to about several hours before chipping off and/or being able to be removed manually (such as with a toothbrush).

The material 250 and mold 200 may be stored separately until application on the patient's teeth is desired. Material 250 is simply applied to the back side, which is preferably concave, of the mold 200. Alternatively, and as shown in the lower part of FIG. 2, mold 200 may be pre-filled with material 250 and stored in that configuration prior to use.

The invention is not limited to the use of just one mold, but may include a system of molds. This is beneficial as patient's will have a varying range of bite clearances, teeth size, and tooth spacing. As such, a kit that includes a plurality of different molds, each mold being adapted to receive a material that may be hardened, may be employed. The plurality of different molds may differ by one or more features, including tooth size, tooth spacing, bite clearance, and number of teeth. The different molds may be then selected by the patient to best match their current teeth configuration, to match a desired aesthetic, to match a bite clearance, or a combination of any of these factors.

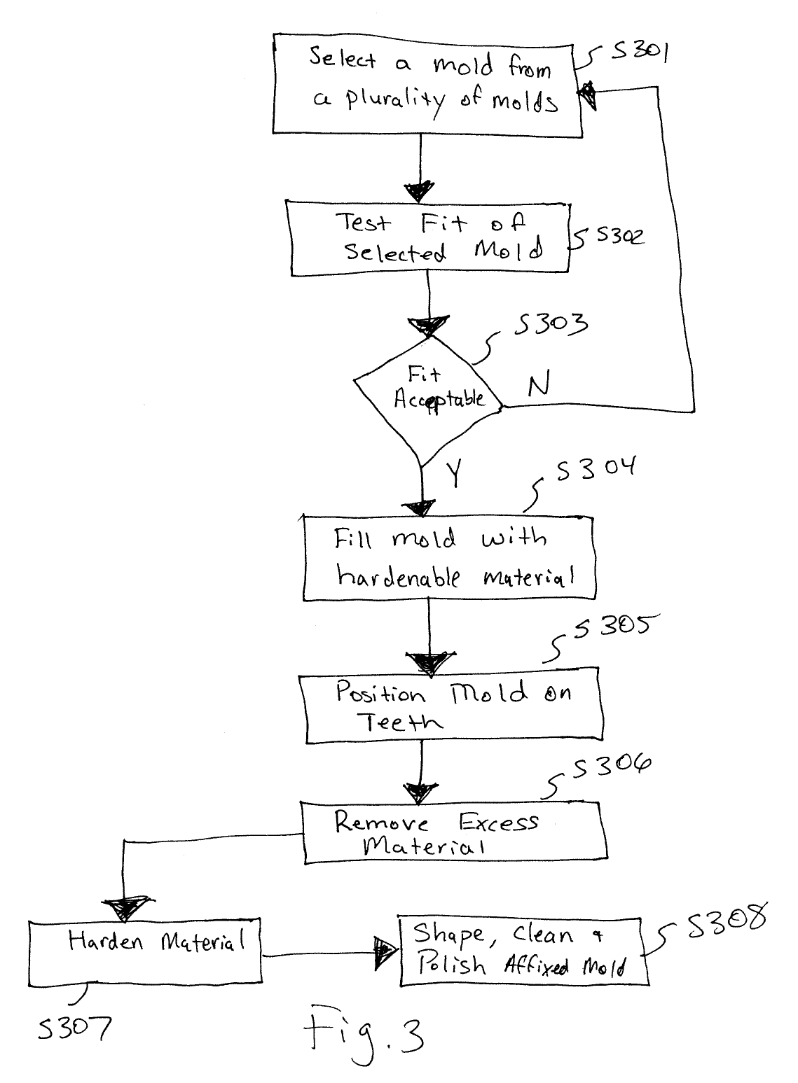

FIG. 3 shows a flowchart of the preferred method for applying temporary dental veneers according to one embodiment of the invention. First in step S301, a mold is selected from among a plurality of different molds. As stated above, this selection may be based on current teeth configuration, a desired aesthetic, a bite clearance, or a combination of any of these factors. Next, in step S302 the fit of the selected mold is tested in the patient's mouth. In step S303, the fit is tested for acceptability. The mold may be unacceptable due to fit, comfort, aesthetics etc. If the fit is not acceptable, the method returns to step S301 and a different mold is selected. If the fit is acceptable, the method proceeds to step S304 where the mold is filled with the hardenable material. Of course, this step would be unnecessary if the molds were pre-filled with the material.

Next in step S305, the mold is positioned on the teeth in preparation for hardening. Then in step S306, any excess hardenable material is removed from the gingival margin of the patient's teeth. The gingival margin is labeled as element 270 in FIG. 2. In step S307 the material is hardened. In this process, the material and the mold become temporarily affixed to the patient's teeth. Finally, in step S308 the temporarily affixed mold and material may be shaped cleaned and polished. The patient will then be able to view a facsimile of permanent dental veneers as they would appear on their own teeth.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A method for applying a temporary dental veneer on a patient's teeth, the method comprising the steps of:
positioning a mold on the patient's teeth, the mold containing a material that may be hardened; and
hardening the material on the patient's teeth, the hardened material being temporarily affixed on the teeth.

2. The method of claim 1 wherein the temporarily affixed hardened material becomes unfixed from the patient's teeth from two hours to two weeks after the material is hardened.

3. The method of claim 1 further including the step of:
selecting a mold from among a plurality of different molds, the selection step occurring prior to the positioning step.

4. The method of claim 3 wherein the plurality of different molds differ by one or more features, including tooth size, tooth spacing, bite clearance, and number of teeth.

5. The method of claim 3 wherein the mold is selected based on aesthetics.

6. The method of claim 3 wherein the mold is selected based on bite clearance.

7. The method of claim 1 wherein the mold is clear.

8. The method of claim 1 further including the step of:
filling the dental mod with the material, the filling step occurring prior to the positioning step.

9. The method of claim 3 further including the steps of:
testing a fit of the selected mold on the patient's mouth; and
selecting a different one of the plurality of different molds if the fit of the selected mold is unacceptable.

10. The method of claim 1 wherein that material is a composite or acrylic material.

11. The method of claim 1 wherein the material is hardened by exposing it to ultraviolet radiation.

12. The method of claim 1 further including the step of:
removing excess material at the gingival margin of the patient's teeth, the removing step occurring after the positioning step but before the hardening step.

13. The method of claim 1 further including the step of:
shaping the mold and the hardened material, the shaping step occurring after the hardening step.

14. The method of claim 1 further including the step of:
polishing and cleaning the patient's teeth, including the mold and the hardened material, the polishing and cleaning step occurring after the hardening step.

15. A method for applying a temporary dental veneer on a patient's teeth, the method comprising the steps of:
selecting a mold from among a plurality of different molds;
testing a fit of the selected mold on the patient's mouth;
selecting a different one of the plurality of different molds if the fit of the selected mold is unacceptable;
filling the dental mod with a material that may be hardened;
positioning the selected mold filled with the material on the patient's teeth;
removing excess material at the gingival margin of the patient's teeth;
hardening the material on the patient's teeth, the hardened material being temporarily affixed on the teeth;
shaping the mold and the hardened material; and
polishing and cleaning the patient's teeth, including the mold and the hardened material.

16. An apparatus for use as a temporary dental veneer comprising:
a mold adapted to receive a material that may be hardened; and
a material that may be hardened, wherein the hardened material is adapted to be temporarily affixed to a patient's teeth.

17. The apparatus of claim 16 wherein the temporarily affixed hardened material becomes unfixed from the patient's teeth from two hours to two weeks after the material is hardened.

18. The apparatus of claim 16 wherein the mold and the material are kept separate until the temporary dental veneer is to be applied to a patient's teeth.

19. The apparatus of claim 16 wherein the mold is pre-filled with the material.

20. The apparatus of claim 16 wherein the mold is clear.

21. The apparatus claim 16 wherein the material is a composite or acrylic material.

22. The apparatus of claim 16 wherein the material is hardened by exposing it to ultraviolet radiation.

23. A system applying a temporary dental veneer comprising:
a plurality of different molds, each mold being adapted to receive a material that may be hardened; and
a material that may be hardened, wherein the hardened material is adapted to be temporarily affixed to a patient's teeth.

24. The system of claim 23 wherein the plurality of different molds differ by one or more features, including tooth size, tooth spacing, bite clearance, and number of teeth.
